(19) United States
(12) Patent Application Publication
(10) Pub. No.: US 2006/0028069 A1
(43) Pub. Date: Feb. 9, 2006

(54) Retrofit kit for converting a transfer switch to a switch for soft-load transfer, and soft-load power distribution system and method

(76) Inventors: David G. Loucks, Coraopolis, PA (US); James R. Hanna, Beaver, PA (US); Krzysztof Patura, Beaver Falls, PA (US); Todd M. Lathrop, Oakdale, PA (US); Ronald D. Hartzel, Penn Township, PA (US)

Correspondence Address: Martin J. Moran, Esquire;Eaton Electrical, Inc., Technology & Quality Center, 170 Industry Drive, RIDC Park West, Pittsburgh, PA, 15275-1032, US

(21) Appl. No.: 10/914,366

(22) Filed: Aug. 9, 2004

(51) Int. Cl. H02H 3/24

(52) U.S. Cl. 307/130

(57) ABSTRACT

A soft-load power distribution system includes a transfer switch having a first input to a utility power source with a utility alternating current (AC) voltage, a second input to a generator power source with a generator AC voltage, and an output to a load. A first switch is electrically connected between the first input and the output and a second switch is electrically connected between the second input and the output. The transfer switch has a third input, such as a go to emergency input, controlling the first and second switches. A bypass switch is electrically connected between the second input and the output. First and second sensors, such as potential transformers, sense the utility and generator AC voltages, respectively. A controller closes the bypass switch when the utility AC voltage is within a predetermined range of the generator AC voltage, and includes an output controlling the third input.

### BACKGROUND OF THE INVENTION

1. Field of the Invention

The present invention relates to power distribution systems and, more particularly, to such systems employing transfer mechanisms, such as, for example, transfer switches. The invention also relates to a retrofit kit for a transfer mechanism, such as, for example, as transfer switch.

2. Background Information

Alternate power sources are provided for any number of applications, which cannot withstand a lengthy interruption in electric power. Typically, power is provided from a primary source with back-up power provided by a secondary source. Often, the primary source is a utility power source and the secondary source is an auxiliary power source, such as an engine driven generator or a second utility source. The transfers between the two power sources can be made automatically or manually.

Transfer switches are well known in the art. See, for example, U.S. Pat. Nos. 5,397,868; 5,210,685; 4,894,796; and 4,747,061. Transfer switches operate, for example, to transfer a power consuming load from a circuit with a normal power supply to a circuit with an auxiliary power supply. Applications for transfer switches include stand-by applications, among others, in which the auxiliary power supply stands-by if the normal power supply should fail. Facilities having a critical requirement for continuous electric power, such as hospitals, certain plant processes, computer installations, and the like, have a standby power source, often a diesel generator. A transfer switch controls electrical connection of the utility lines and the diesel generator to the facility load buses. In many installations, the transfer switch automatically starts the standby generator and connects it to the load bus upon loss of utility power, and reconnects the utility power to the load bus if utility power is reestablished.

In the case of a generator driven auxiliary power source, power must be stabilized before the transfer can be made to the secondary source. In any event, the two power sources cannot be connected to the load simultaneously unless they suitably match their respective voltages, frequencies and phases. Some transfer switches affect an open transition between the power sources, that is, one is disconnected from the load bus before the other one is connected. Other transfer switches provide a closed transition wherein the one source is connected to the load bus before the other source is disconnected, in order that both power sources are connected in parallel during the transition.

Transfer switches commonly used to connect alternate power sources to a load, including networks, utilize a pair of switches each connecting one of the sources to the load. In order to prevent connecting unsynchronized sources together, the operation of the two switches is coordinated, typically by a mechanical interlock, in order that only one switch at a time can be turned on. In many instances, it is desirable to operate the transfer switch remotely. Typically, electric motors have been used to operate the interlocks on transfer switches. See, for example, U.S. Pat. Nos. 5,081,367; 4,760,278; and 4,398,097.

A transfer switch typically comprises a pair of circuit interrupters combined with a drive input and a linkage system. The preferred types of circuit interrupters have been molded-case switches and molded-case circuit breakers because these types are commercially available in a wide array of sizes and are relatively economical compared to other options. The preferred type of drive input depends on the application for the transfer switch. Usually motors are preferred, but at other times there is a clear preference for manually-operated mechanisms.

Certain facilities, processes or applications benefit from having a “soft-load” transfer from one power source to another. By reducing the “outage” or “transient” from a conventional open or closed transition, transfer switches have been shown, for example, to reduce battery degradation within uninterruptible power supply (UPS) systems. A known method of providing a soft-load transfer when the power system includes an open transition switch requires removing the existing open transition switch and replacing it with a new switch.

A known peaking switch retrofit permits adding the ability for an existing open transition switch to parallel both incoming sources and simultaneously supply the load from both sources. Such a peaking switch includes engine governor and voltage regulator control to permit a “soft” or “zero-power” transfer from one power source to another power source. As shown in FIG. 1, when a shorting switch 2 is closed, a load 4 receives power from both a normal utility power source 6 and from a generator power source 8. This allows a generator 9 to run and supply power while a transfer switch 10 is connected to the utility power source 6, but not to the generator power source 8.

However, known peaking switches are designed to supply the load from both sources and do not include a method of disconnecting the load from one source and transferring the load to the second source as would be needed, for example, during monthly generator testing at, for example, a hospital, when the goal is, for example, to transfer the load from the utility power source to the generator power source for such testing and, then, to disconnect from the utility power source without causing a transient during such transfer. Known peaking switches also do not facilitate a transfer, since while they permit paralleling of two sources, they do not include any mechanism to smoothly disconnect one source while maintaining a live source continuously connected to the load.

There remains, therefore, the need to provide a soft-load closed transition function if the user wishes to transfer the load to the generator power source and disconnect it from the utility power source, or to re-transfer the load to the utility power source and disconnect it from the generator power source and circumstances are favorable toward keeping the existing transfer switch installed. Those circumstances include, for example: (1) wiring was previously cut and terminated at existing terminals that may or may not reach new equipment termination points, necessitating new cabling be pulled; or (2) the inability to remove or install a new transfer switch due to subsequent construction of the facility that has now limited entry or egress of oversized equipment.

Accordingly, there is room for improvement in transfer switches, and in power distribution systems and methods employing the same.

### SUMMARY OF THE INVENTION

These needs and others are met by the present invention, which allows a conventional transfer switch to remain installed as part of a power distribution system.

In accordance with one aspect of the invention, a retrofit kit converts a transfer switch to a switch for soft-load transfer. The transfer switch includes a first input to a first power source having a first alternating current voltage, a second input to a second power source having a second alternating current voltage, an output to a load, a first switch electrically connected between the first input and the output, a second switch electrically connected between the second input and the output, and a third input controlling the first and second switches. The retrofit kit comprises: a third switch adapted to be electrically connected between the second input and the output; a first sensor adapted to sense the first alternating current voltage at the first input; a second sensor adapted to sense the second alternating current voltage at the second input; and a controller adapted to close the third switch when the first alternating current voltage is within a predetermined range of the second alternating current voltage, the controller including an output adapted to be electrically connected to the third input of the transfer switch.

The second power source may be a generator power source including a generator having a throttle. The controller may confirm that the third switch is closed and responsively increase a signal to the throttle before the output of the controller sends a signal to the third input of the transfer switch to open the first switch and to close the second switch.

The controller may decrease the signal to the throttle before the output of the controller sends a signal to the third input of the transfer switch to close the first switch and to open the second switch.

The controller may confirm that the third switch is closed and responsively send a signal from the output to the third input of the transfer switch to open the first switch and to close the second switch. The controller may open the third switch a predetermined time after the transfer switch opens the first switch and closes the second switch.

As another aspect of the invention, a soft-load power distribution system comprises: a transfer switch comprising: a first input to a first power source having a first alternating current voltage, a second input to a second power source having a second alternating current voltage, an output to a load, a first switch electrically connected between the first input and the output, a second switch electrically connected between the second input and the output, and a third input controlling the first and second switches; a third switch electrically connected between the second input and the output; a first sensor sensing the first alternating current voltage at the first input; a second sensor sensing the second alternating current voltage at the second input; and a controller closing the third switch when the first alternating current voltage is within a predetermined range of the second alternating current voltage, the controller including an output electrically connected to the third input of the transfer switch.

As another aspect of the invention, a method of providing a soft-load from a transfer switch comprises: employing the transfer switch including a first input to a first power source having a first alternating current voltage, a second input to a second power source having a second alternating current voltage, an output to a load, a first switch electrically connected between the first input and the output, a second switch electrically connected between the second input and the output, and a third input controlling the first and second switches; electrically connecting a third switch between the second input and the output; sensing the first alternating current voltage at the first input; sensing the second alternating current voltage at the second input; electrically connecting an output to the third input of the transfer switch; and closing the third switch when the first alternating current voltage is within a predetermined range of the second alternating current voltage, in order to parallel the first and second alternating current voltages, which provide power to the load.

The method may employ a utility power source as the first power source; employ a generator power source as the second power source; and receive an external signal and responsively switch from the utility power source to the generator power source.

The method may employ an engine operatively associated with the generator power source; and start the engine responsive to the receiving an external signal. The method may employ a speed associated with the engine; employ a first frequency and a first phase angle associated with the utility power source; employ a second frequency and a second phase angle associated with the generator power source; adjust the speed of the engine to adjust the second frequency to about equal the first frequency and the second phase angle to about equal the first phase angle; adjust the second alternating current voltage to about equal the first alternating current voltage; close the third switch; open the second switch; and close the first switch to restore the utility power source to the load.

The method may disable the generator power source, and open the third switch a predetermined time after confirming the switching from the generator power source to the utility power source.

### BRIEF DESCRIPTION OF THE DRAWINGS

A full understanding of the invention can be gained from the following description of the preferred embodiments when read in conjunction with the accompanying drawings in which:

FIG. 1 is a block diagram of a peaking switch retrofit to permit adding a closed transition to an existing open transition transfer switch for a normal utility power source and a generator power source.

FIG. 2 is a block diagram of a soft-load transfer retrofit (STR) device for a transfer switch in accordance with the present invention.

FIG. 3 is a timing diagram showing a typical sequence for switching the load from the utility power source to the generator power source and back again when using the soft-load transfer retrofit (STR) device of FIG. 2.

FIGS. 4A and 4B are block diagrams of the transfer switch and the STR device of FIG. 2 including the interconnections therebetween in accordance with two embodiments of the invention.

FIGS. 5A1-5A2 and 5B1-5B2 are block diagrams of the transfer switch and the STR device of FIG. 2 including interconnections therebetween in accordance with two other embodiments of the invention.

FIGS. 6A-6D form a flowchart of the logic of FIG. 2.

### DESCRIPTION OF THE PREFERRED EMBODIMENTS

As employed herein, the terms “soft-load” or “soft-load transfer” shall expressly include, but not be limited by, a “soft-load” transfer, a “zero-power” transfer and/or a “soft-transfer”.

The present invention is described in association with a transfer switch for three-phase power sources and loads, although the invention is applicable to a wide range of transfer switches for power sources and loads having any number of phases.

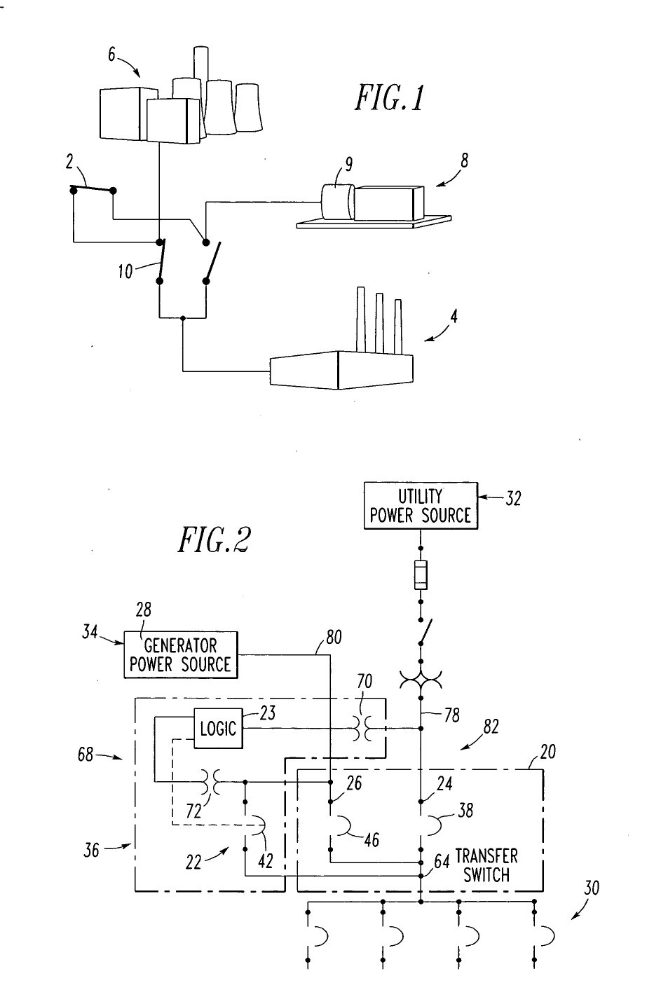

Referring to FIG. 2, a conventional mechanically interlocked open transition transfer switch 20 is converted to a closed transition transfer switch by adding a bypass switch 22 and associated logic 23. As was discussed above in connection with FIG. 1, the switch 2 is electrically connected between the normal power terminal and the emergency power terminal. In contrast, the bypass switch 22 of FIG. 2 parallels the generator side of the transfer switch 20, which, in effect, allows the generator 28 to remain paralleled to the generator switch 46 even when the automatic transfer switch 20 is switched to its normal (utility) position. Hence, the bypass switch 22 is electrically connected in parallel with the generator switch 46 rather than between the normal and emergency incoming power terminals 24 and 26, respectively.

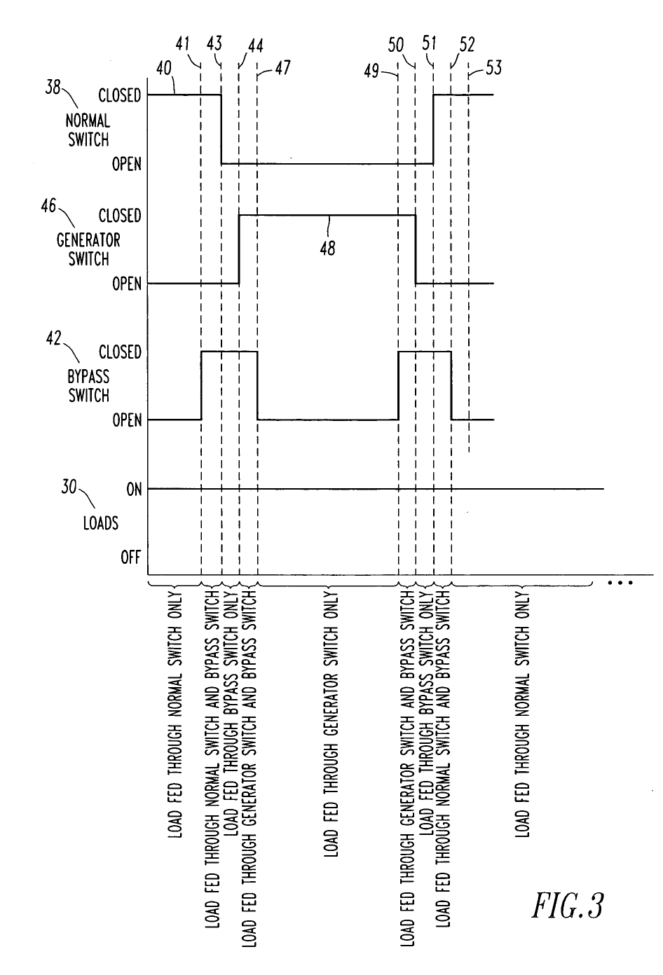

FIG. 3 shows a typical sequence for switching the load(s) 30 of FIG. 2 from the utility power source 32 to the generator power source 34 and back again when using the soft-load transfer retrofit (STR) device 36 of FIG. 2. The times 40, 41, 43, 44 and 47-53 relate to the switching times of the switches 38,42,46 of FIG. 2 and are shown for purposes of illustration and not of limitation. It will be appreciated that a wide range of switching times and/or intervals may be employed.

Continuing to refer to FIGS. 2 and 3, initially, the load 30 is fed through the normal switch 38 only. At 40, only the normal switch 38 is closed. Next, at 41, the bypass switch 42 is closed and the load 30 is fed through the normal switch 38 and the bypass switch 42. Then, at 43, the normal switch 38 is opened and the load 30 is fed through the bypass switch 42 only. Next, at 44, the generator switch 46 is closed and the load 30 is fed through the generator switch 46 and the bypass switch 42. Then, at 47, the bypass switch 42 is opened and the load 30 is fed through the generator switch 46 only. After this time, at 48, suitable testing of the generator 28 may be conducted as it powers the load 30.

After the generator tests are completed, the bypass switch 42 is closed, at 49, and the load 30 is fed through the generator switch 46 and the bypass switch 42. Next, at 50, the generator switch 46 is opened and the load 30 is fed through the bypass switch 42 only. Then, at 51, the normal switch 38 is closed and the load 30 is fed through the normal switch 38 and the bypass switch 42. Finally, at 52, the bypass switch 42 is opened and the load 30 is fed through the normal switch 38 only. This re-establishes the initial state, at 53. In accordance with an important aspect of the invention, throughout the various transitions of FIG. 3, the load 30 is never interrupted.

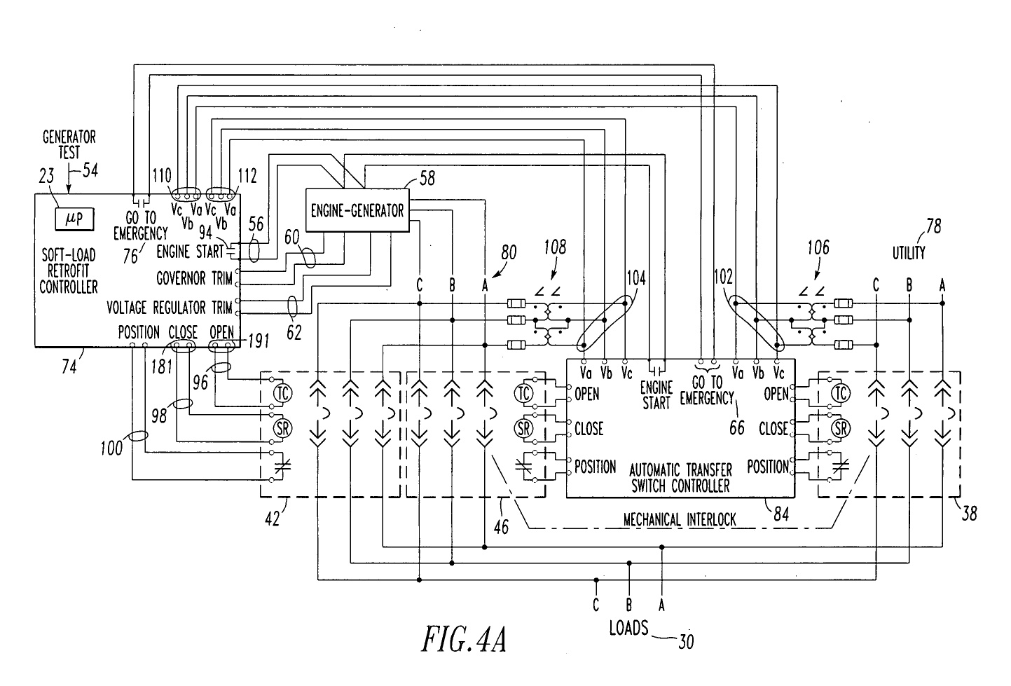

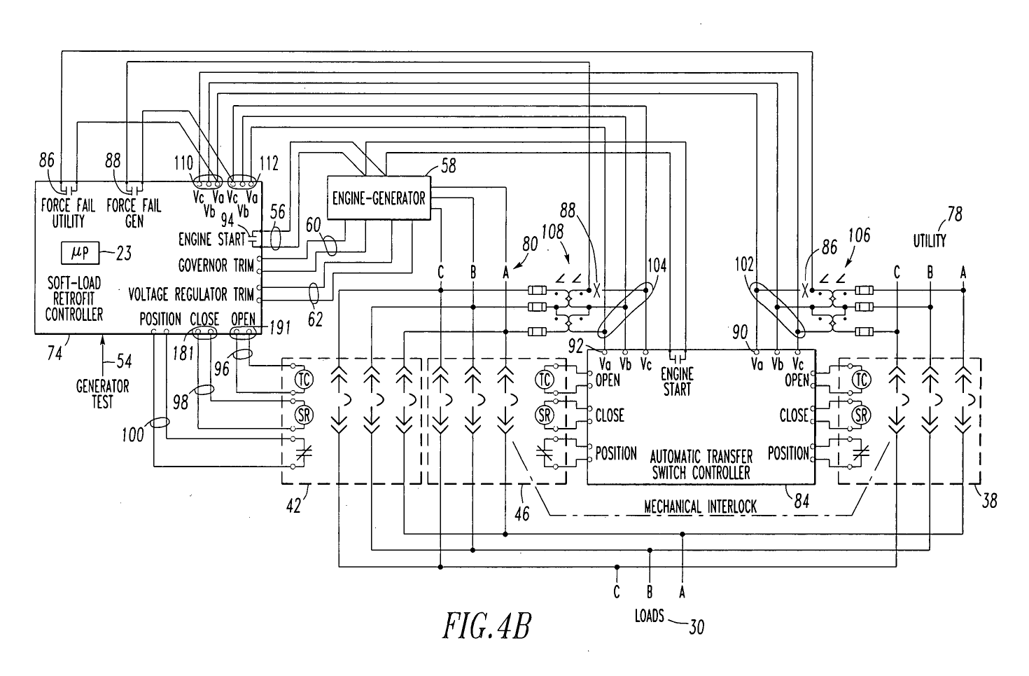

As shown by FIG. 3, at no time does the load 30 experience even a momentary disturbance. This is accomplished through the following sequence of events. Initially, at about 40, a generator test signal 54 (FIGS. 4A,4B and 5A1-5A2,5B1-5B2) (e.g., without limitation, an external contact closure; any suitable electronic or communicated signal) is received. This signal 54 directs that the STR device 36 (FIG. 2) should switch from the utility power source 32 to the generator power source 34. Then, an engine start signal 56 (FIGS. 4A,4B and 5A1-5A2,5B1-5B2) is given to the engine-generator set 58 (FIGS. 4A,4B and 5A1-5A2,5B1-5B2) of the generator 28 from the STR device 36. Next, the STR device 36 sends a speed correcting governor output signal 60 (FIGS. 4A,4B and 5A1-5A2,5B1-5B2) to bring the engine speed and, therefore, the generator frequency of the generator 28 (FIG. 2) suitably close (e.g., without limitation, within about 0.1 Hz to about 0.3 Hz of frequency deviation) to the utility frequency of the utility power source 32. As the generator frequency reaches a value sufficiently close to the utility frequency, the STR device 36 begins to adjust the generator speed in relatively small increments to ensure that the generator voltage phase angle is suitably close (e.g., without limitation, within about +/−10°) to the utility voltage phase angle. Concurrent with this phase adjustment, a separate voltage adjustment signal 62 from the STR device 36 is sent to the generator voltage regulator (not shown) of the engine-generator set 58 to ensure that the generator voltage is suitably close (e.g., without limitation, about 97% to about 103% of the other voltage) to the utility voltage.

Continuing to refer to FIGS. 2 and 3, when the voltage, frequency and phase angle of the generator 28 are suitably matched to the voltage, frequency and phase angle of the utility power source 32, the bypass switch 42 closes, at 41, thereby paralleling the output, at 26, from the generator 28 with the output, at 24, from the utility power source 32 and, thus, both power sources 28,32 begin providing power to the load 30.

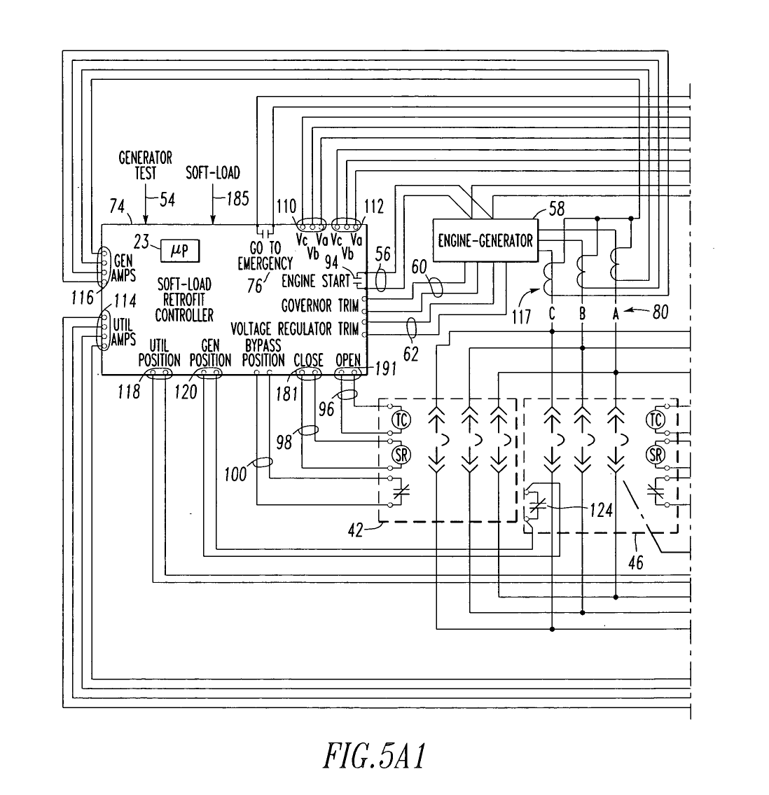

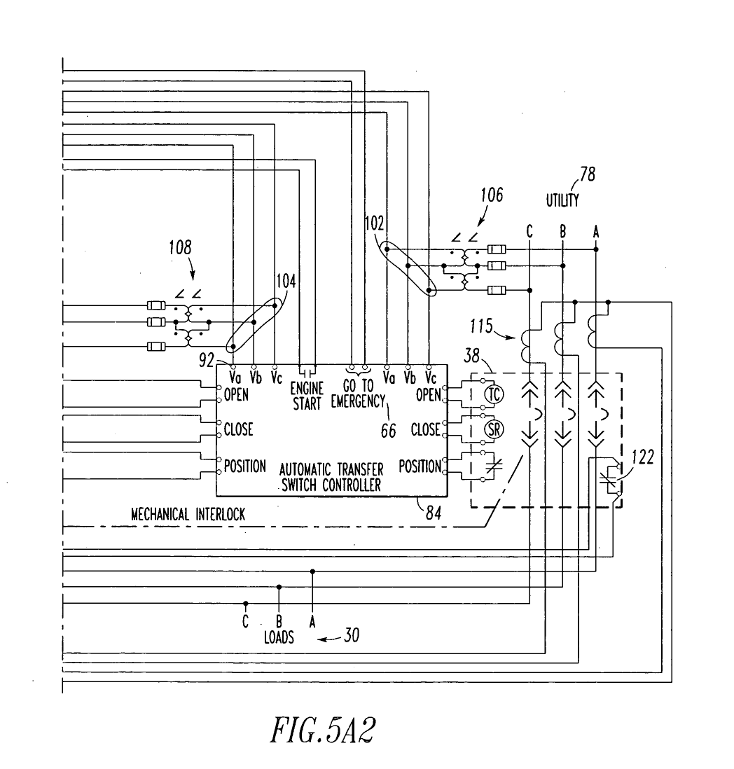

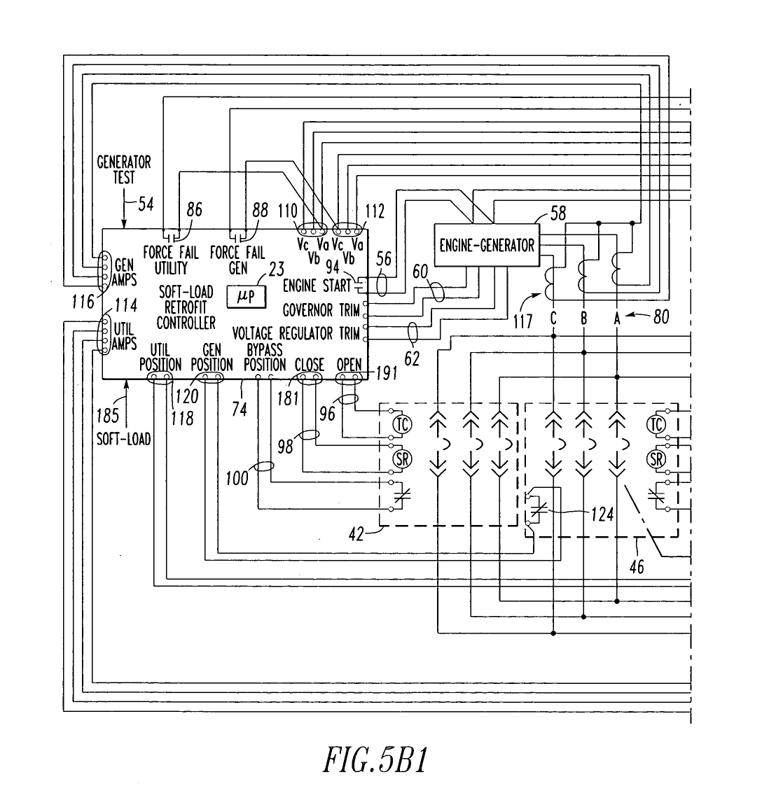

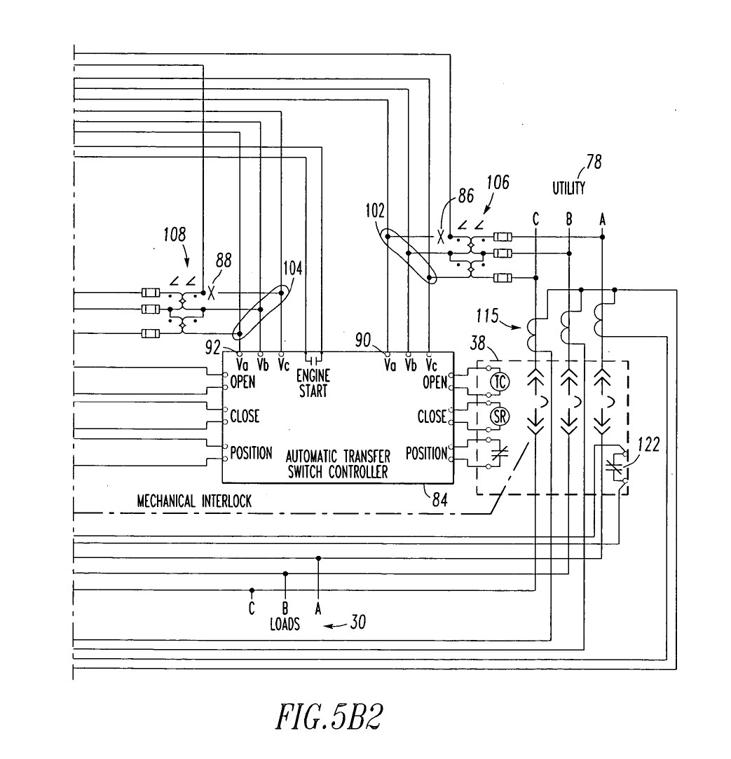

Referring again to FIG. 2, as is conventional, the transfer switch 20 include a first input, such as the normal power terminal 24, to a first power source, such as the utility power source 32, having a first alternating current (AC) voltage, and a second input, such as the emergency power terminal 26, to a second power source, such as the generator power source 34, having a second AC voltage. The transfer switch 20 also includes an output 64 to the load 30, a first switch, such as the normal switch 38, which is electrically connected between the first input 24 and the output 64, a second switch, such as the generator switch 46, which is electrically connected between the second input 26 and the output 64, and a third input (e.g., go to emergency input 66 of FIGS. 4A and 5A1-5A2) controlling the first and second switches 38,46.

A retrofit kit 68 (FIG. 2) for converting a conventional transfer switch to a switch for soft-load transfer includes the bypass switch 42, a first sensor 70 adapted to sense the first (utility) AC voltage 78 at the first input 24, a second sensor 72 adapted to sense the second (generator) AC voltage 80 at the second input 26, and a controller 74 (FIGS. 4A,4B and 5A1-5A2,5B1-5B2) having the logic 23 and being adapted to close the bypass switch 42 when the first AC voltage 78 is within a predetermined range of the second AC voltage 80. The controller 74 includes an output (e.g., go to emergency output 76 of FIGS. 4A and 5A1-5A2) adapted to be electrically connected to the third input 66 (FIGS. 4A and 5A1-5A2) of the transfer switch 20.

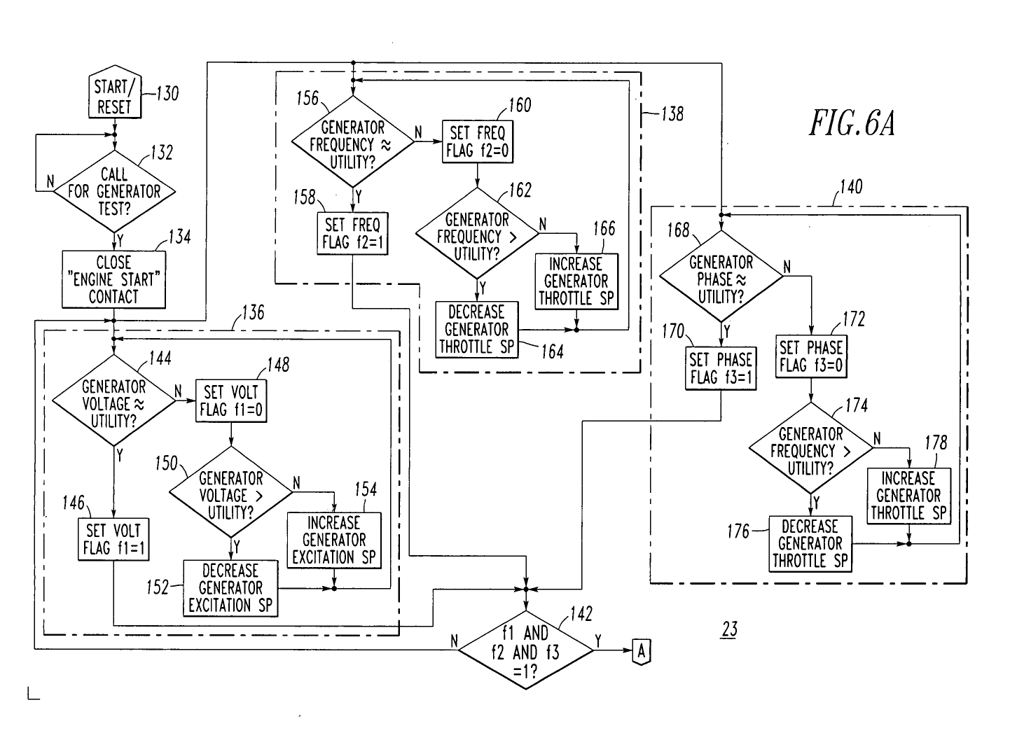

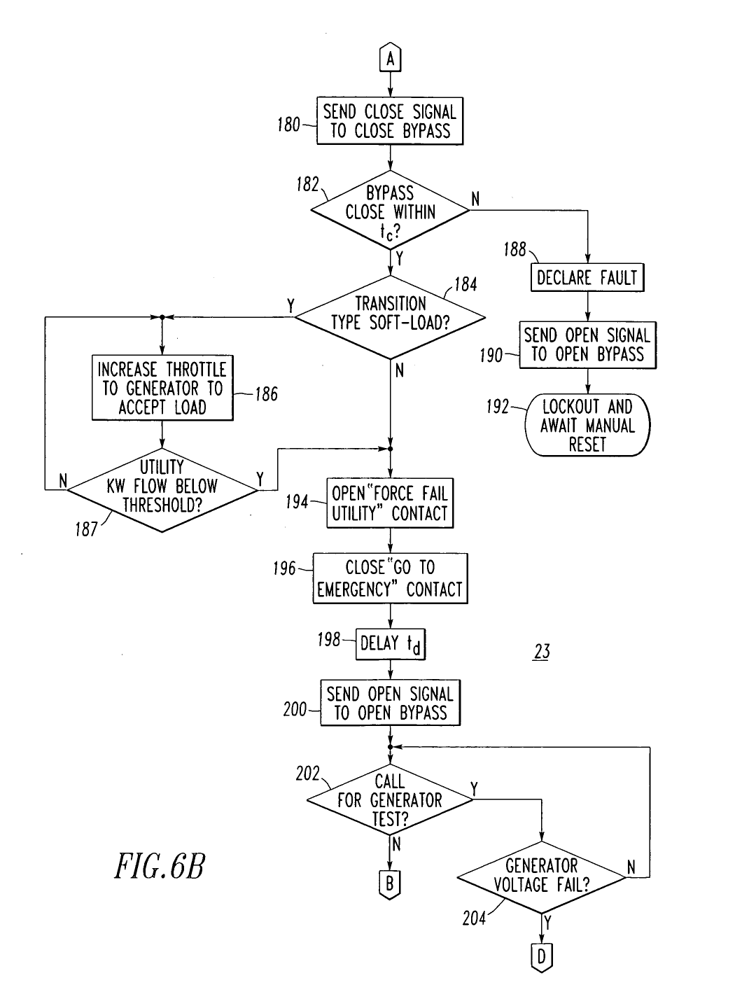

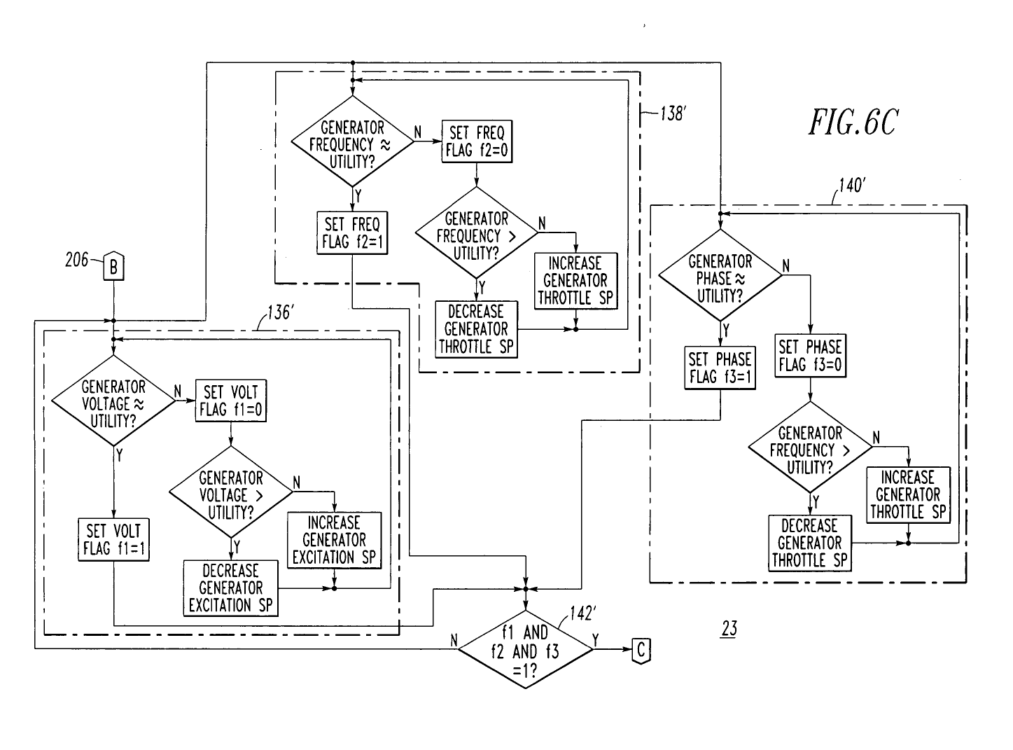

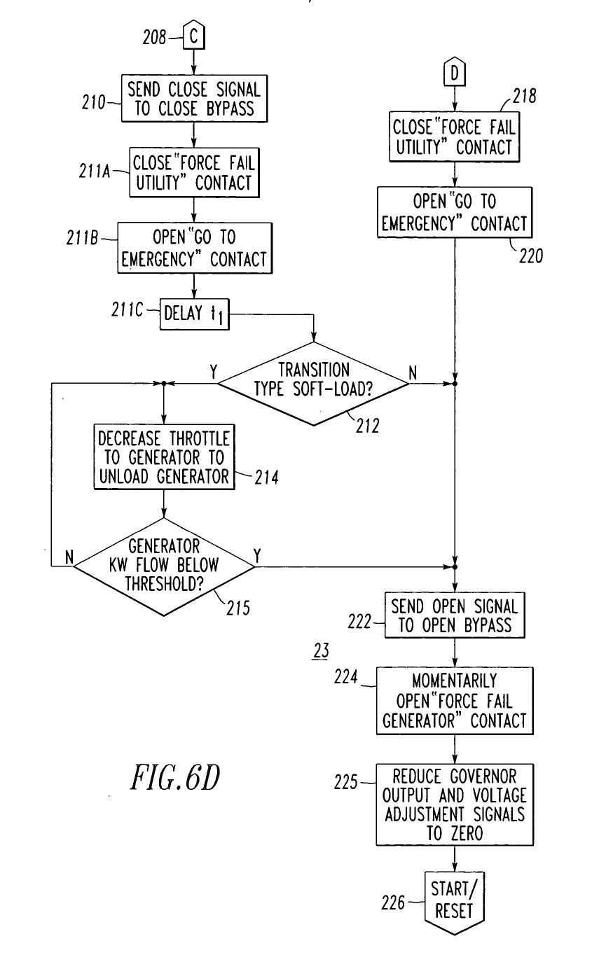

As will be discussed in greater detail, below, in connection with FIGS. 6A and 6C, the utility AC voltage 78 includes a voltage, a frequency and a phase angle, and the generator AC voltage 80 includes a voltage, a frequency and a phase angle. The controller 74 is adapted to close the bypass switch 42 when the voltage of the utility AC voltage 78 is within a first predetermined amount of the voltage of the generator AC voltage 80, when the frequency of the utility AC voltage is within a second predetermined amount of the frequency of the generator AC voltage, and when the phase angle of the utility AC voltage is within a third predetermined amount of the phase angle of the generator AC voltage.

As is conventional, the transfer switch 20 (FIG. 2) causes an immediate transfer from one of the first and second inputs 24,26 to the other of those inputs upon loss of one of the utility and generator AC voltages 78,80, respectively.

A soft-load power distribution system 82 (FIG. 2) includes the transfer switch 20, the bypass switch 42, the sensors 70,72 and the controller 74 (FIGS. 4A,4B and 5A1-5A2,5B1-5B2).

The STR device 36 (FIG. 2) can be configured for either soft-load transfer (FIGS. 5A1-5A2,5B 1-5B2) or delayed (e.g., 100 ms) transfer (FIGS. 4A,4B), depending upon application (e.g., customer; utility) requirements. For the soft-load transfer mode, as will be discussed in additional detail below in connection with FIG. 6B, the STR device 36 increases the governor output signal 60 (FIGS. 5A1-5A2,5B1-5B2), which causes the generator 28 (FIG. 2) to accept more of the load 30 from the utility power source 32. Then, after the utility power source 32 has dropped below a suitable predetermined minimum kW flow (as determined at 187 of FIG. 6B), the STR device 36 sends a signal (e.g., from output 76 of FIGS. 5A1-5A2) to the transfer switch 20 telling it to transfer to generator 28.

For the delayed transfer mode, after the STR device 36 has confirmed that the bypass switch 42 has closed, the STR device 36 sends a signal (e.g., from output 76 of FIG. 4A) to the transfer switch 20 telling such transfer switch to immediately transfer to the generator 28. There are several possibilities of sending such a signal to the existing transfer switch 20 depending on the type of options installed in that transfer switch. To minimize warranty or Underwriters Laboratory (UL) issues, the STR device 36 preferably does not directly control the power switching devices 38,46 in the transfer switch 20. Instead, the STR device 36 sends a suitable signal (e.g., from output 76) to the controller 84 (FIGS. 4A,4B and 5A1-5A2,5B1-5B2) of the transfer switch 20 and permits that controller to switch the associated power-switching devices 38,46.

### EXAMPLE 1

As shown in FIGS. 4A and 5A1-5A2, if the controller 84 of the transfer switch 20 supports the external “go to emergency” input 66, then the STR device 36 (FIG. 2) drives that input from the output 76.

### EXAMPLE 2

If the option of Example 1 is not available, then the STR device 36 places dry contacts 86,88, as shown in FIGS. 4B and 5B1-5B2, into one phase's (e.g., phase A) voltage sense lead 90,92 on both the utility and generator power sources 32,34, respectively. Since both power sources 32,34 are available, a “failure” caused by one of the contacts 86,88 being open on one of those sources 32,34, respectively, will cause an immediate transfer to the other source by the transfer switch controller 84.

In this example, the third input of the transfer switch 20 (FIG. 2) includes the utility (phase A) voltage sense input 90 (FIGS. 4B and 5B1-5B2) receiving the utility AC voltage (Va) of the voltages 102 and the generator (phase A) voltage sense input 92 receiving the generator AC voltage (Va) of the voltages 104. The controller 74 includes the first contact 86 adapted to be electrically connected in series with the utility voltage sense input 90, and the second contact 88 adapted to be electrically connected in series with the generator voltage sense input 92. As will be discussed below in connection with FIGS. 6B and 6D, the controller 74 opens one of the first and second contacts 86,88 to open one and close another one of the first and second switches 38,46, respectively.

In order to restore the utility power source 32 (FIG. 2), the STR device 36 re-synchronizes the generator 28 with the utility power source 32, closes the bypass switch 42, at 49 (FIG. 3), and re-transfers the load 30 back to the utility power source 32, at 51 (FIG. 3). After the bypass switch 42 has closed, the control signal (either the “go to emergency” signal from output 76 (FIGS. 4A and 5A1-5A2) or the re-closure of the first dry contact 86 (FIGS. 4B and 5B1-5B2) that, again, represents that the utility power source 32 is available and the opening of the second dry contact 88 (FIGS. 4B and 5B1-5B2) in series with the generator power source 34 that represents that the generator 28 is not available) is sent to the transfer switch controller 84.

As will be apparent from FIG. 6D, depending on whether a soft or a delayed transfer is selected, the bypass switch 42 remains closed for either the entire time that the output power of the generator 28 is ramped down or it opens a suitable time (e.g., 100 ms) after a confirmed re-transfer to the utility power source 32 has occurred.

Finally, the STR device 36 opens an engine start contact 94 (FIGS. 4A,4B and 5A1-5A2,5B1-5B2) that drives the signal 56 and the unloaded engine of the generator 28 (FIG. 2) cools down. If the engine does not include an integral cool-down time delay, then the engine start contact 94 remains closed for a pre-programmed time delay to allow the engine sufficient time to cool down.

FIGS. 4A,4B and 5A1-5A2,5B1-5B2 show the transfer switch controller 84 and the switches 38,46 of the transfer switch 20 of FIG. 2 as well as the soft-load retrofit controller 74 and bypass switch 42, including the interconnections therebetween. The controller 74 opens, closes and monitors the bypass switch 42 through the signals 96, 98 and 100, respectively. The controller 74, as is discussed below in connection with FIGS. 6A-6D, also monitors the utility voltages 102 and the generator voltages 104 as obtained from open delta transformers 106 and 108 to permit synchronization of both power source AC voltages 78 and 80, respectively. The open delta transformer configuration is one of several possible configurations including, but not limited to: direct connection, delta-wye and delta-delta. The controller 74 adjusts generator frequency and voltage to allow synchronization with the frequency and voltage, respectively, of the utility power source 32 (FIG. 2). The controller 74 also independently calls for start of the engine-generator 58. In FIGS. 4A and 5A1-5A2, the controller 74 outputs the “Go to Emergency” signal from the output 76 to the transfer switch controller 84 to force such transfer switch controller to switch between the utility AC voltage 78 and the generator AC voltage 80.

Referring to FIGS. 5A1-5A2 and 5B1-5B2, in order to support soft-load transfer, the controller 74 meters power (e.g., kW, kVA and/or kvar as obtained from measuring voltage and current) on both of the power sources. For this purpose, the controller 74 includes three-phase voltage inputs 110 for the utility voltages 102, three-phase voltage inputs 112 for the generator voltages 104, three-phase current inputs 114 from three current transformers 115 for utility currents, and three-phase current inputs 116 from three current transformers 117 for generator currents. The controller 74 also includes inputs 118 and 120 that receive optional position indication contacts 122 and 124 from the utility switch 38 and the generator switch 46, respectively.

As will be discussed below in connection with FIG. 6B, in the soft-load transfer mode, the controller 74 confirms that the bypass switch 42 is closed by monitoring the status signal 100 and, then, responsively increases the governor output signal 60 to the generator throttle before the controller 74 initiates the opening of the utility switch 38 and the closing of the generator switch 46.

As shown with reference to FIGS. 5B1-5B2, the controller 74 causes a perceived voltage failure on a selected one of the utility AC voltage 78 and the generator AC voltage 80 by opening a corresponding voltage signal to the transfer controller 84 through one of the contacts 86 and 88 to force the transfer controller to switch between the utility power source 32 (FIG. 2) and the generator power source 34 (FIG. 2).

Referring to FIGS. 6A-6D, the logic 23 (FIG. 2) of the controller 74 is shown. The logic 23, which applies to any of FIGS. 4A,4B and 5A1-5A2,5B1-5B2, starts at 130 following a power-up or reset. Next, at 132, it is determined if a generator test is requested based upon the input 54 of FIGS. 4A,4B and 5A1-5A2,5B1-5B2. At this point, of the three switches 38,46,42, only the utility switch 38 is closed, and the generator and bypass switches 46,42 are open. Then, at 134, the engine start contact 94 is closed.

The decision loops 136, 138 and 140 for generator voltage, generator frequency and generator phase, respectively, preferably are PID (i.e., proportional-integral-derivative) control loops that run in parallel with each other until the test, at 142, determines that the generator voltage, generator frequency and generator phase of the generator AC voltage 104 are about equal the respective utility voltage, utility frequency and utility phase of the utility AC voltage 102.

In particular, for the generator voltage PID decision loop 136, at 144, it is determined if the three-phase generator voltage at input 112 is about equal (e.g., without limitation, within about +/−3%) to the three-phase utility voltage at input 110. If so, then the flag f1 is set true at 146, after which the test, at 142, is conducted. Otherwise, the flag f1 is set false at 148, after which, at 150, it is determined if the three-phase generator voltage at input 112 is greater than the three-phase utility voltage at input 110. If so, then the setpoint (SP) for the generator excitation is decreased, at 152, before step 144 is repeated. On the other hand, if the three-phase generator voltage is less than the three-phase utility voltage, then the setpoint (SP) for the generator excitation is increased, at 154, before step 144 is repeated.

For the generator frequency PID decision loop 138, at 156, it is determined if the three-phase generator frequency, as determined from the AC voltages at input 112, is about equal (e.g., without limitation, within about 0.1 Hz to about 0.3 Hz) to the three-phase utility frequency as determined from the AC voltages at input 110. If so, then the flag f2 is set true at 158, after which the test, at 142, is conducted. Otherwise, the flag f2 is set false at 160, after which, at 162, it is determined if the three-phase generator frequency is greater than the three-phase utility frequency. If so, then the setpoint (SP) for the generator throttle is decreased, at 164, before step 156 is repeated. On the other hand, if the three-phase generator frequency is less than the three-phase utility frequency, then the setpoint (SP) for the generator throttle is increased, at 166, before step 156 is repeated. For a three-phase system, for example, all three phase voltages, frequencies and phase angles are within the criteria described above before the two sources are allowed to be paralleled.

For the generator phase PID decision loop 140, at 168, it is determined if the three-phase generator phase angle, as determined from the AC voltages at input 112, is about equal (e.g., without limitation, within about +/−10°) to the three-phase utility phase angle as determined from the AC voltages at input 110. If so, then the flag f3 is set true at 170, after which the test, at 142, is conducted. Otherwise, the flag f3 is set false at 172, after which, at 174, it is determined if the three-phase generator frequency is greater than the three-phase utility frequency. If so, then the setpoint (SP) for the generator throttle is decreased, at 176, before step 168 is repeated. On the other hand, if the three-phase generator frequency is less than the three-phase utility frequency, then the setpoint (SP) for the generator throttle is increased, at 178, before step 168 is repeated.

The tests of the generator and utility voltages, frequencies and phase angles at steps 144, 156 and 168, respectively, check if the respective signals deviate from the desired value by less than a corresponding predetermined, user-programmable acceptable limit. For example, too small a limit value causes it to be relatively more difficult to synchronize the two power sources. On the other hand, too large a limit value results in a disturbance when the two power sources are paralleled.

The generator excitation and throttle setpoint (SP) values are desired operating points for the various PID control loops 136,138,140.

If the test, at 142, fails, in which case one or more of the flags f1,f2,f3 was false, then execution resumes at 144,156,168. Otherwise, if the test passes, in which case all of the flags f1,f2,f3 are true, then execution resumes at 180 of FIG. 6B. At 180, the close signal 98 is output from output 181 by the controller 74. This causes the bypass switch 42 to begin to close. Then, at 182, it is determined if the bypass switch 42 closes within a time t_{c}, which is a predetermined maximum allowable time (e.g., without limitation, about 100 ms to about 300 ms) to close that bypass switch. If the test passes, at 182, then, at 184, it is determined if the transition type (e.g., as defined by an input 185 or memory location (not shown) of the controller 74) is the soft-load transfer of FIGS. 5A1-5A2 and 5B1-5B2. If so, then, at 186, the controller 74 increases the governor output signal 60. Next, at 187, it is determined if the utility kW flow is below a user configurable threshold. If not, then step 186 is repeated. Otherwise, execution resumes at 194. On the other hand, if the test fails, at 182, then, at 188, a fault is declared. Then, at 190, the open signal 96 is output from output 191 by the controller 74. This causes the bypass switch 42 to begin to open. Finally, the controller 74 enters a lockout mode, at 192, in which a manual reset is required. The close signal 98 and the open signal 96 are preferably momentary signals of suitable duration (e.g., without limitation, about 1 second), although a wide range of signal types, levels and/or durations may be employed.

If the test fails at 184, then the delayed transfer mode is selected, step 186 is not executed and execution resumes at 194. At 194, the controller 74 opens the “Force Fail Utility” contact 86 of FIGS. 4B and 5B1-5B2 and, at 196, closes the “Go to Emergency” contact 76 of FIGS. 4A and 5A1-5A2. This permits the logic 23 to operate with any of the modes of FIGS. 4A, 4B, 5A1-5A2 and 5B1-5B2. Alternatively, the logic 23 may be customized for one or more of those modes. Step 194, or step 196 functions to close the generator switch 46 and to open the utility switch 38.

After 196, step 198 delays for a predetermined time t_{d}, which is the measured time from (1) the opening of the “Force Fail Utility” contact 86 or the closing of the “Go to Emergency” contact 76 until (2) the transfer switch 20 (FIG. 2) transfers the load from the utility power source 32 to the generator power source 34. It will be appreciated that this time td varies depending on the type of transfer switch equipment that was previously installed and may be suitably measured and entered by those of ordinary skill in the relevant art.

For the delayed transfer mode, the predetermined time td may be set to a suitable delay value (e.g., 1 second). Alternatively, for applications that use switch position indicators 122 and 124, this time may be reduced to about zero. It will be appreciated, however, that a wide range of delay values may be employed.

Next, at 200, the open signal 96 is output from output 191 by the controller 74. This causes the bypass switch 42 to begin to open. At 202, it is determined if a generator test is still requested based upon the input 54 of FIGS. 4A,4B and 5A1-5A2,5B1-5B2. At this point, of the three switches 38,46,42, only the generator switch 46 is closed, the bypass switch 42 is opening and the utility switch 38 is open. If the generator test is not requested, then execution resumes at 206 of FIG. 6C. Otherwise, if the generator test is requested, then, at 204, it is determined if the generator AC voltage 104, as input at 112, has failed and fallen below a suitable predetermined value (e.g., without limitation, below about 90% of a rated voltage). If not, then step 202 is repeated. Otherwise, execution resumes at 218 of FIG. 6D, since if the generator power source 34 (FIG. 2) fails during testing it is desirable to switch back to the utility power source 32 (FIG. 2) as soon as possible.

FIG. 6C repeats the decision loops 136,138,140 and test 142 of FIG. 6A, which are shown here as decision loops 136′,138′,140′ and test 142′, although it will be appreciated that the same decisions and logic are employed. This ensures that the generator voltage, generator frequency and generator phase of the generator AC voltage 104 about equal the respective utility voltage, utility frequency and utility phase of the utility AC voltage 102, before the transfer back (FIG. 6D) to the utility power source 32 (FIG. 2) is initiated. If the test at 142′ fails, then, step 206 is repeated. Otherwise, step 208 of FIG. 6D is executed. At this point, of the three switches 38,46,42, only the generator switch 46 is closed, and the utility and bypass switches 38,42 are open.

At 210, the close signal 98 is output from output 181 by the controller 74. This causes the bypass switch 42 to begin to close. Next, at 211A, the controller 74 closes the “Force Fail Utility” contact 86 of FIGS. 4B and 5B1-5B2 and, at 211B, opens the “Go to Emergency” contact 76 of FIGS. 4A and 5A1-5A2. This permits the logic 23 to operate with any of the modes of FIGS. 4A, 4B, 5A1-5A2 and 5B1-5B2. Alternatively, the logic 23 may be customized for one or more of those modes. Step 211A or step 211B functions to close the utility switch 38 and to open the generator switch 46. After 211B, step 211C delays for a predetermined time t₁, which is the measured time from (1) the closing of the “Force Fail Utility” contact 86 or the opening of the “Go to Emergency” contact 76 until (2) the transfer switch 20 (FIG. 2) transfers the load from the generator power source 34 to the utility power source 32. It will be appreciated that this time t₁ varies depending on the type of transfer switch equipment that was previously installed and may be suitably measured and entered by those of ordinary skill in the relevant art. The time t₁ is, thus, the allowed time to permit the utility switch 38 to close before opening the bypass switch 42.

Then, at 212, it is determined if the transition type (e.g., as defined by the input 185 or memory location (not shown) of the controller 74) is the soft-load transfer of FIGS. 5A1-5B2 and 5B1-5B2. If so, then, at 214, the controller 74 decreases the governor output signal 60, in order to unload the generator 28 (FIG. 2). Next, at 215, it is determined if the generator kW flow is below a suitable user configurable threshold. If not, then step 214 is repeated. Otherwise, execution resumes at 222.

If the test at 204 of FIG. 6B passed, then, at 218, the controller 74 closes the “Force Fail Utility” contact 86 of FIGS. 4B and 5B1-5B2 and, at 220, opens the “Go to Emergency” contact 76 of FIGS. 4A and 5A1-5A2. This functions to close the utility switch 38 and to open the generator switch 46. Next, at 222, which follows one of 220, if the test passes at 215 or if the test at 212 fails, the open signal 96 is output from output 191 by the controller 74. This causes the bypass switch 42 to begin to open. At this point, of the three switches 38,46,42, only the generator switch 46 is open, the bypass switch 42 is opening and the utility switch 38 is closed. At 224, the controller 74 momentarily opens the “Force Fail Generator” contact 88 of FIGS. 4B and 5B1-5B2. This ensures for the modes of FIGS. 4B and 5B1-5B2, that the load 30 is transferred back to the utility power source 32 (FIG. 2). Next, at 225, after the termination of the engine cool down cycle, the governor output signal 60 and the voltage adjustment signal 62 are reduced to zero. Finally, step 226 initiates a start/reset, which causes execution to resume at step 130 of FIG. 6A.

It will be appreciated that the controller 74 (FIGS. 4A,4B and 5A1-5A2,5B1-5B2) may be implemented with a combination of one or more of analog, digital and/or processor-based (e.g., μP) circuits.

The disclosed STR device 36 (FIG. 2) does not affect either UL listing or warranty of an existing transfer switch, such as 20. This is especially important if the existing transfer switch 20 is marketed by a different entity than the proprietor of the STR device 36. Furthermore, the STR device 36 provides for ease of installation, since no wiring must be removed and there is no equipment to be disposed.

The size of the disclosed retrofit kit 68 (FIG. 2) is substantially determined by the size of the corresponding bypass switch 42, which, typically for a given retrofit, would be about one-half of the size and about one-half of the cost of the switches 38,46 of the corresponding transfer switch 20. Hence, for installations where it is impractical to remove and replace the transfer switch 20, the introduction of the bypass switch 42 of the retrofit kit 68 provides a practical and a relatively lower cost alternative.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A retrofit kit for converting a transfer switch to a switch for soft-load transfer, said transfer switch including a first input to a first power source having a first alternating current voltage, a second input to a second power source having a second alternating current voltage, an output to a load, a first switch electrically connected between said first input and said output, a second switch electrically connected between said second input and said output, and a third input controlling said first and second switches, said retrofit kit comprising:
a third switch adapted to be electrically connected between said second input and said output;
a first sensor adapted to sense the first alternating current voltage at said first input;
a second sensor adapted to sense the second alternating current voltage at said second input; and
a controller adapted to close said third switch when said first alternating current voltage is within a predetermined range of said second alternating current voltage, said controller including an output adapted to be electrically connected to the third input of said transfer switch.

2. The retrofit kit of claim 1 wherein said first power source is a utility power source.

3. The retrofit kit of claim 1 wherein said second power source is a generator power source.

4. The retrofit kit of claim 1 wherein the first alternating current voltage includes a voltage, a frequency and a phase angle; wherein the second alternating current voltage includes a voltage, a frequency and a phase angle; and wherein said controller is adapted to close said third switch (i) when the voltage of the first alternating current voltage is within a first predetermined amount of the voltage of the second alternating current voltage, (ii) when the frequency of the first alternating current voltage is within a second predetermined amount of the frequency of the second alternating current voltage, and (iii) when the phase angle of the first alternating current voltage is within a third predetermined amount of the phase angle of the second alternating current voltage.

5. The retrofit kit of claim 1 wherein said third input includes a first voltage sense input receiving the first alternating current voltage and a second voltage sense input receiving the second alternating current voltage; wherein said controller includes a first contact adapted to be electrically connected in series with said first voltage sense input, a second contact adapted to be electrically connected in series with said second voltage sense input, and means for opening one of said first and second contacts to open one and close another one of said first and second switches.

6. The retrofit kit of claim 1 wherein said second power source is a generator power source including a generator having a throttle; and wherein said controller confirms that the third switch is closed and responsively increases a signal to said throttle before the output of said controller sends a signal to the third input of said transfer switch to open said first switch and to close said second switch.

7. The retrofit kit of claim 6 wherein the third input of said transfer switch is a go to emergency input.

8. The retrofit kit of claim 6 wherein the third input of said transfer switch includes a first voltage sense input receiving the first alternating current voltage and a second voltage sense input receiving the second alternating current voltage; wherein said controller includes a first contact adapted to be electrically connected in series with said first voltage sense input, a second contact adapted to be electrically connected in series with said second voltage sense input, and means for opening one of said first and second contacts to open one and close another one of said first and second switches.

9. The retrofit kit of claim 6 wherein said controller decreases the signal to said throttle before the output of said controller sends a signal to the third input of said transfer switch to close said first switch and to open said second switch.

10. The retrofit kit of claim 1 wherein said controller confirms that the third switch is closed and responsively sends a signal from said output to the third input of said transfer switch to open said first switch and to close said second switch; and wherein said controller opens said third switch a predetermined time after said transfer switch opens said first switch and closes said second switch.

11. The retrofit kit of claim 1 wherein said transfer switch causes an immediate transfer from one of said first and second inputs to the other of said first and second inputs upon loss of one of said first and second alternating current voltages, respectively.

12. A soft-load power distribution system comprising:
a transfer switch comprising:
a first input to a first power source having a first alternating current voltage,
a second input to a second power source having a second alternating current voltage,
an output to a load,
a first switch electrically connected between said first input and said output,
a second switch electrically connected between said second input and said output, and
a third input controlling said first and second switches;
a third switch electrically connected between said second input and said output;
a first sensor sensing the first alternating current voltage at said first input;
a second sensor sensing the second alternating current voltage at said second input; and
a controller closing said third switch when said first alternating current voltage is within a predetermined range of said second alternating current voltage, said controller including an output electrically connected to the third input of said transfer switch.

13. The soft-load power distribution system of claim 12 wherein said first power source is a utility power source.

14. The soft-load power distribution system of claim 12 wherein said second power source is a generator power source.

15. The soft-load power distribution system of claim 12 wherein the first alternating current voltage includes a voltage, a frequency and a phase angle; wherein the second alternating current voltage includes a voltage, a frequency and a phase angle; and wherein said controller is adapted to close said third switch (i) when the voltage of the first alternating current voltage is within a first predetermined amount of the voltage of the second alternating current voltage, (ii) when the frequency of the first alternating current voltage is within a second predetermined amount of the frequency of the second alternating current voltage, and (iii) when the phase angle of the first alternating current voltage is within a third predetermined amount of the phase angle of the second alternating current voltage.

16. A method of providing a soft-load from a transfer switch, said method comprising:
employing said transfer switch including a first input to a first power source having a first alternating current voltage, a second input to a second power source having a second alternating current voltage, an output to a load, a first switch electrically connected between said first input and said output, a second switch electrically connected between said second input and said output, and a third input controlling said first and second switches;
electrically connecting a third switch between said second input and said output;
sensing the first alternating current voltage at said first input;
sensing the second alternating current voltage at said second input;
electrically connecting an output to the third input of said transfer switch; and
closing said third switch when said first alternating current voltage is within a predetermined range of said second alternating current voltage, in order to parallel the first and second alternating current voltages, which provide power to the load.

17. The method of claim 16 further comprising
employing a utility power source as said first power source;
employing a generator power source as said second power source; and
receiving an external signal and responsively switching from the utility power source to the generator power source.

18. The method of claim 17 further comprising
employing an engine operatively associated with said generator power source; and
starting said engine responsive to said receiving an external signal.

19. The method of claim 18 further comprising
employing a speed associated with said engine;
employing a first frequency and a first phase angle associated with said utility power source;
employing a second frequency and a second phase angle associated with said generator power source;
adjusting the speed of said engine to adjust said second frequency to about equal said first frequency and said second phase angle to about equal said first phase angle; and
adjusting the second alternating current voltage to about equal the first alternating current voltage.

20. The method of claim 17 further comprising
employing a speed associated with said engine;
employing a first frequency and a first phase angle associated with said utility power source;
employing a second frequency and a second phase angle associated with said generator power source;
adjusting the speed of said engine to adjust said second frequency to about equal said first frequency and said second phase angle to about equal said first phase angle;
adjusting the second alternating current voltage to about equal the first alternating current voltage;
closing the third switch;
opening the second switch; and
closing the first switch to restore the utility power source to said load.

21. The method of claim 20 further comprising
disabling the generator power source.

22. The method of claim 21 further comprising
opening the third switch a predetermined time after switching from the generator power source to the utility power source.
